(19) United States
(12) Patent Application Publication
(10) Pub. No.: US 2025/0309541 A1
(43) Pub. Date: Oct. 2, 2025

(54) ANTENNA STRUCTURE

(71) Applicant: Wistron NeWeb Corporation, Hsinchu (TW)

(72) Inventors: Nien-Tzu CHUNG, Hsinchu (TW); Tsun-Che HUANG, Hsinchu (TW)

(21) Appl. No.: 19/014,898

(22) Filed: Jan. 9, 2025

(30) Foreign Application Priority Data
Mar. 28, 2024 (TW) 113111715

(51) Int. Cl. H01Q 9/04; H01Q 1/32; H01Q 1/48; H01Q 21/00; H01Q 21/06

(52) U.S. Cl. CPC H01Q 9/0414; H01Q 1/32; H01Q 1/48; H01Q 21/0075; H01Q 21/065

(57) ABSTRACT

An antenna structure includes a feeding layer, a patch antenna layer, a slot antenna layer, a serial patch antenna layer, a plurality of first via structures, and a plurality of second via structures. The feeding layer includes a feeding portion configured to feed a signal. The patch antenna layer includes a grounding layer and a patch antenna. The slot antenna layer includes a slot. The serial patch antenna layer includes a serial patch antenna group. The serial patch antenna group includes a plurality of patch antenna units. The first via structures are connected to the slot antenna layer and the patch antenna layer. The second via structures are connected to the slot antenna layer and the feeding layer. The signal is from the feeding layer through the patch antenna layer, the slot antenna layer, and couple and resonate with the serial patch antenna layer.

### RELATED APPLICATIONS

This application claims the benefit of priority to Taiwan Patent Application No. 113111715, filed on Mar. 28, 2024. The entire content of the above identified application is incorporated herein by reference.

### BACKGROUND

### Technical Field

The present disclosure relates to an antenna structure, in particular to an antenna structure for an automotive radar.

### Description of Related Art

In order to avoid accidents and ensure driving safety, automotive radar needs to accurately locate vehicles, passengers, and surrounding obstacles. As an important component in automotive radar, antennas must have the characteristics of high performance, small size, low cost, and easy manufacturing. Microstrip antennas are smaller than reflector and lens antennas and are easy to form in vehicles.

In addition, serial feeding antenna arrays are mostly fed through end-feeds. However, end-feeds tend to lead to longer radiated waveguides, which in turn leads to narrower bandwidth. When the antenna array size is large, long line effect and beam squint will have a greater impact.

In view of this, the development of an antenna structure that can avoid long line effect and beam squint has become a worthy goal for the relevant industry.

### SUMMARY

According to one embodiment of the present disclosure, an antenna structure is provided which includes a feeding layer, a patch antenna layer, a slot antenna layer, a serial patch antenna layer, a plurality of first via structures, and a plurality of second via structures. The feeding layer includes a feeding portion configured to feed a signal. The patch antenna layer includes a grounding layer and a patch antenna. A spacing is between the grounding layer and the patch antenna, and the patch antenna corresponds to the feeding portion. The slot antenna layer includes a slot, and the slot corresponds to the patch antenna. The serial patch antenna layer includes a serial patch antenna group. The serial patch antenna group includes a plurality of patch antenna units. One of the patch antenna units partially overlaps with the feeding portion in a vertical projection direction. These first via structures are connected to the slot antenna layer and the patch antenna layer. These second via structures are connected to the slot antenna layer and the feeding layer. The signal is from the feeding layer through the patch antenna layer, the slot antenna layer, and couples and resonates with the serial patch antenna layer.

According to another embodiment of the present disclosure, an antenna structure is provided which includes a feeding layer, a patch antenna layer, a slot antenna layer, a serial patch antenna layer, a plurality of first via structures, and a plurality of second via structures. The feeding layer includes a plurality of feeding portions, which are configured to feed a plurality of signals respectively. The patch antenna layer includes a grounding layer and a plurality of patch antennas. A spacing is between the grounding layer and each of the patch antennas. The patch antennas correspond to each of the feeding portions respectively. The slot antenna layer includes a plurality of slots. The slots correspond to the patch antennas, respectively. The serial patch antenna layer includes a plurality of serial patch antenna groups. Each of the serial patch antenna groups includes a plurality of patch antenna units, and one of the patch antenna units of each of the serial patch antenna groups partially overlaps with the feeding portions in a vertical projection direction. The first via structures are connected to the slot antenna layer and the patch antenna layer. The second via structures are connected to the slot antenna layer and the feeding layer. These signals are from the feeding layer through the patch antenna layer, the slot antenna layer, and couple and resonate with the serial patch antenna layer.

### BRIEF DESCRIPTION OF THE DRAWINGS

The described embodiments may be better understood by reference to the following description and the accompanying drawings, in which:

FIG. 1 is a schematic decomposition view of an antenna structure according to a first embodiment of the present disclosure.

FIG. 2 is a schematic view of a feeding layer of the antenna structure of FIG. 1.

FIG. 3 is a schematic view of a patch antenna layer of the antenna structure of FIG. 1.

FIG. 4 is a schematic view of a slot antenna layer of the antenna structure of FIG. 1.

FIG. 5 is a schematic view of a serial patch antenna layer of the antenna structure of FIG. 1.

FIG. 6 is a schematic view of the first via structures and the second via structures of the antenna structure of FIG. 1.

FIG. 7 is a perspective view of the antenna structure of FIG. 1.

FIG. 8 is a schematic parametric view of the antenna structure of FIG. 1.

FIG. 9 is another schematic parametric view of the antenna structure of FIG. 1.

FIG. 10 is a schematic return loss view of the antenna structure of FIG. 1.

FIG. 11 is a smith chart of the antenna structure of FIG. 1.

FIG. 12 is a schematic decomposition view of an antenna structure according to a second embodiment of the present disclosure.

FIG. 13 is a perspective view of the antenna structure of FIG. 12.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

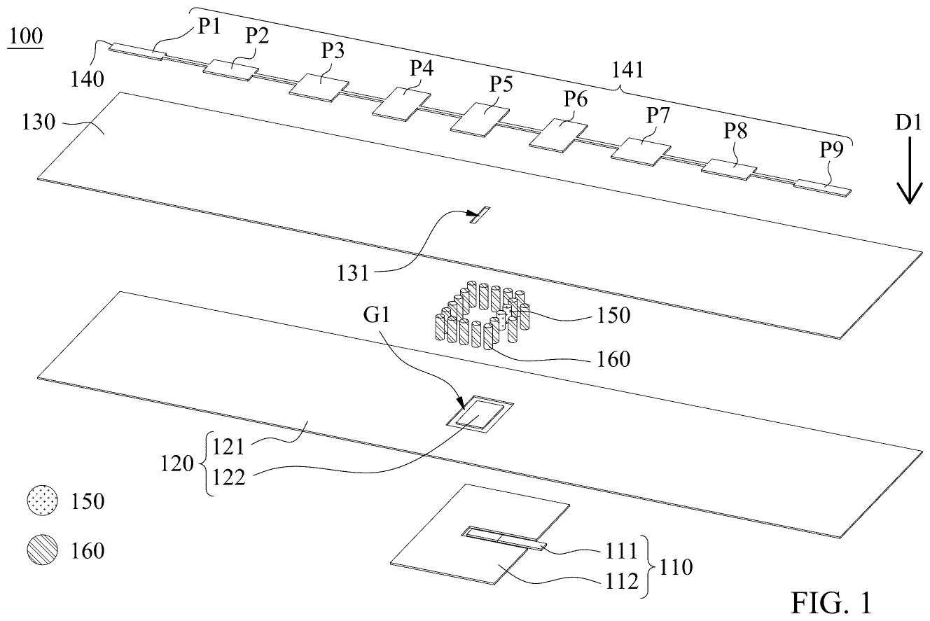

Referring to FIG. 1. FIG. 1 is a schematic decomposition view of an antenna structure 100 according to a first embodiment of the present disclosure. The antenna structure 100 includes a feeding layer 110, a patch antenna layer 120, a slot antenna layer 130, a serial patch antenna layer 140, a plurality of first via structures 150, and a plurality of second via structures 160. The feeding layer 110 includes a feeding portion 111 configured to feed a signal. The patch antenna layer 120 includes a grounding layer 121 and a patch antenna 122. A spacing G1 is between the grounding layer 121 and the patch antenna 122, and the patch antenna 122 corresponds to the feeding portion 111. The slot antenna layer 130 includes a slot 131, and the slot 131 corresponds to the patch antenna 122. The serial patch antenna layer 140 includes a serial patch antenna group 141. The serial patch antenna group 141 includes a plurality of patch antenna units P1, P2, P3, P4, P5, P6, P7, P8, P9. One of the patch antenna units P1-P9 partially overlaps with the feeding portion 111 in a vertical projection direction D1. The first via structures 150 are connected to the slot antenna layer 130 and the patch antenna layer 120. The second via structures 160 are connected to the slot antenna layer 130 and the feeding layer 110. The signal is from the feeding layer 110 through the patch antenna layer 120, the slot antenna layer 130, and couples and resonates with the serial patch antenna layer 140.

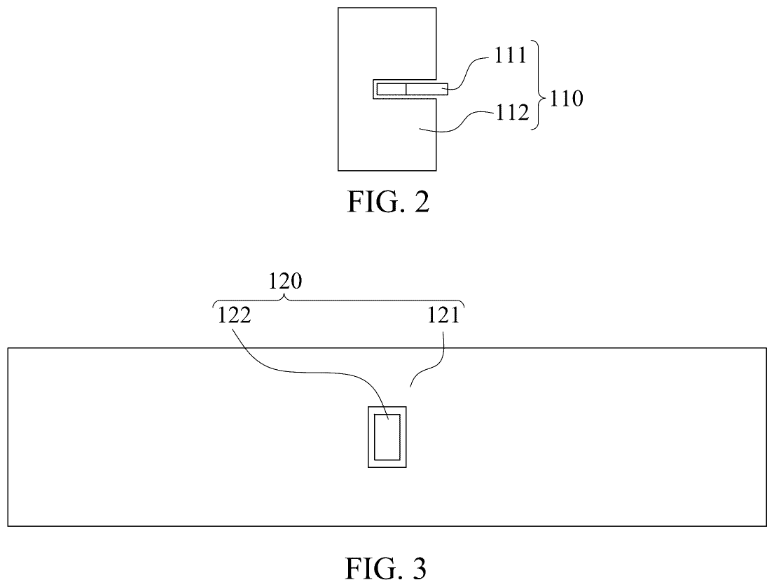

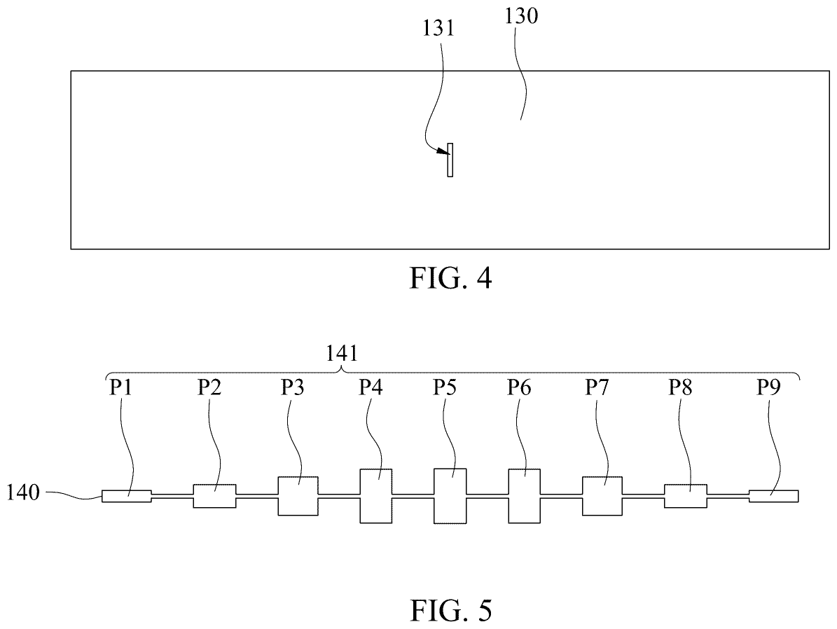

Referring to FIG. 1 to FIG. 5. FIG. 2 is a schematic view of the feeding layer 110 of the antenna structure 100 of FIG. 1. FIG. 3 is a schematic view of the patch antenna layer 120 of the antenna structure 100 of FIG. 1. FIG. 4 is a schematic view of the slot antenna layer 130 of the antenna structure 100 of FIG. 1. FIG. 5 is a schematic view of the serial patch antenna layer 140 of the antenna structure 100 of FIG. 1. The feeding portion 111 can be a microstrip antenna, and a setting position of the first via structures 150 correspond to the microstrip antenna. A setting position of the feeding portion 111 corresponds to a middle position of the serial patch antenna layer 140. In FIG. 1, the feeding layer 110 can further include a grounding layer 112. The feeding portion 111 and the first via structures 150 are disposed on the right side of the antenna structure 100, but the present disclosure is not limited thereto. Thus, the antenna structure 100 of the present disclosure can solve the problem of beam squint.

The number of patch antenna units P1-P9 is an odd number. When the number of the patch antenna units P1-P9 is N, a setting position of the feeding portion 111 corresponds to (N+1)/2 of the patch antenna units P5. For example, the number of the patch antenna units P1-P9 in FIG. 1 is 9, and the setting position of the feeding portion 111 corresponds to the 5th patch antenna unit P5, counted from right to left or from left to right. In other words, the setting position of the feeding portion 111 corresponds to the middlemost patch antenna unit P5. Therefore, the radiation effect of the antenna structure 100 is enhanced and the long line effect is avoided.

In the first embodiment, the shape of the grounding layer 112, the patch antenna 122, the slot 131, and the patch antenna units P1-P9 can be adjusted according to the required impedance matching or frequency parameters of the antenna structure 100.

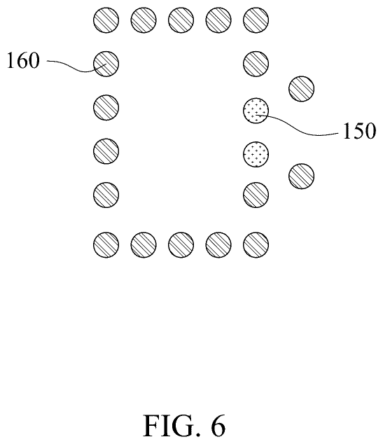

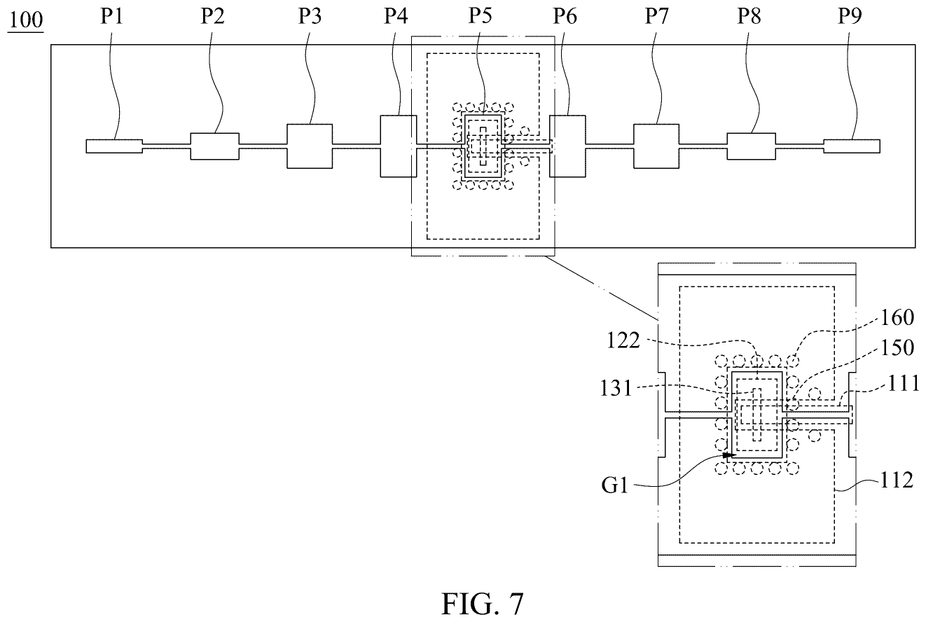

Referring to FIG. 1, FIG. 6, and FIG. 7. FIG. 6 is a schematic view of the first via structures 150 and the second via structures 160 of the antenna structure 100 of FIG. 1. FIG. 7 is a perspective view of the antenna structure 100 of FIG. 1. When observing the patch antenna layer 120 and the slot antenna layer 130 along the vertical projection direction D1, the first via structures 150 and the second via structures 160 surround the spacing G1 and the patch antenna 122. At least a part of the first via structures 150 and the second via structures 160 are arranged at equal intervals. In the first embodiment, the number of the first via structures 150 is two, and they are arranged with part of the second via structures 160 at equal intervals and surround the spacing G1 and the patch antenna 122. The number of the second via structures 160 is eighteen, but the present disclosure is not limited thereto. The higher the density of the first via structures 150 and the second via structures 160 surrounding the spacing G1 and the patch antenna 122, the better the waveguide effect of the antenna structure 100 will be.

Since the via structure is prone to errors during the manufacturing process, when the via structure is used to transmit signals, the errors in the manufacturing process will cause great errors in the overall performance and efficiency of the antenna. The first via structures 150 and the second via structures 160 in the present disclosure are configured to connect the grounding structure (i.e., the grounding layer 112, the grounding layer 121, and the grounding layer (reference is omitted) in the slot antenna layer 130) and waveguide, not for signal transmission. Therefore, the efficiency and frequency performance of the antenna structure 100 in the present disclosure will not be affected by the via structure error in the manufacturing process.

In the first embodiment, the feeding layer 110, the patch antenna layer 120, the slot antenna layer 130, and the serial patch antenna layer 140 are stacked sequentially from bottom to top, but the present disclosure is not limited thereto. The antenna structure 100 feeds signals from the feeding portion 111 of the feeding layer 110, and transmits the signals to the serial patch antenna layer 140 through the patch antenna 122 of the patch antenna layer 120 and the slot 131 of the slot antenna layer 130, so that the patch antenna units P1-P9 resonate.

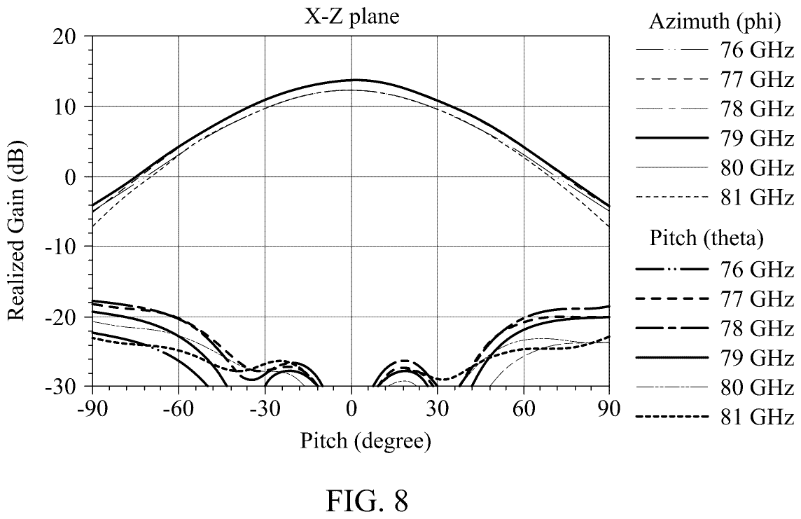

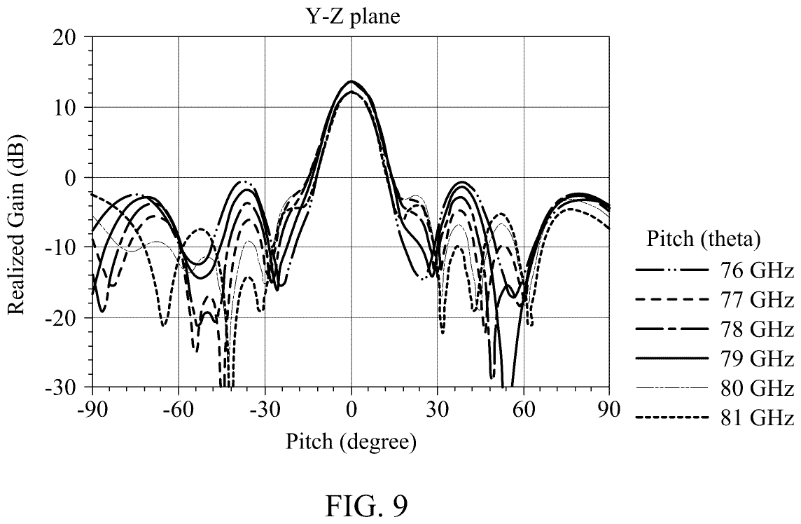

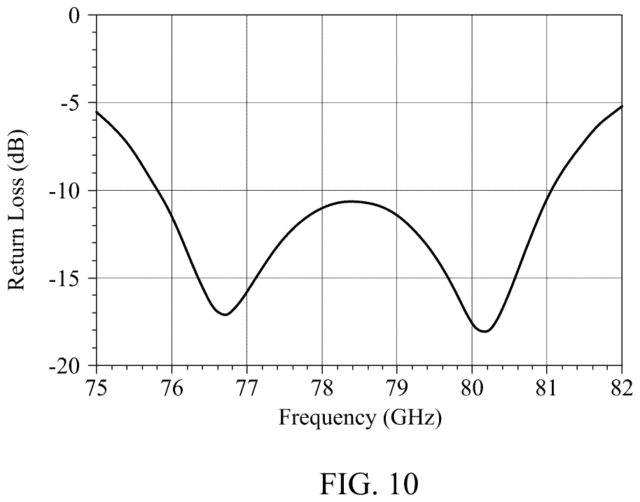

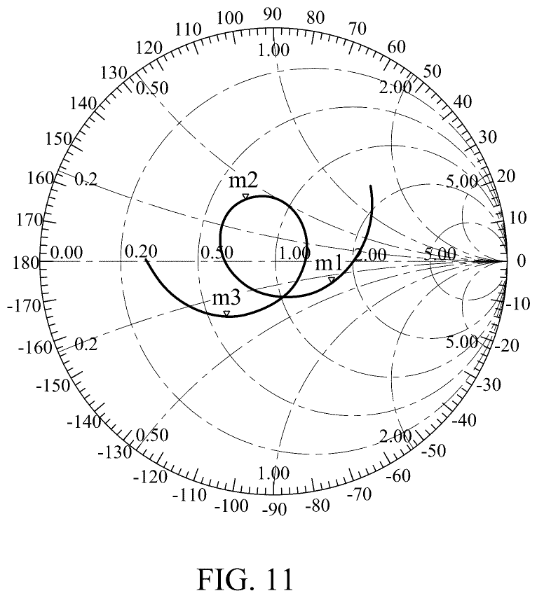

Referring to FIG. 1 and FIG. 8 to FIG. 11. FIG. 8 is a schematic parametric view of the antenna structure 100 of FIG. 1. FIG. 9 is another schematic parametric view of the antenna structure 100 of FIG. 1. FIG. 10 is a schematic return loss view of the antenna structure 100 of FIG. 1. FIG. 11 is a smith chart according to the antenna structure of FIG. 1. FIG. 8 and FIG. 9 are realized gain of the antenna structure 100 on X-Z plane and Y-Z plane respectively. The antenna structure 100 has a resonance frequency between 76 GHz and 81 GHz. In FIG. 10, when the frequency of the antenna structure 100 is between 76 GHz and 81 GHz, the return loss is smaller than −10 dB. Therefore, the bandwidth of the antenna structure 100 in the present disclosure is greater than 5 GHz. Referring to Table 1 for frequencies, phase angles, impedances, and real and imaginary parts of impedances of measurement points m1, m2, and m3 in FIG. 11.

TABLE 1

| | | | | Impedance |
|---|---|---|---|---|
| | | | | (real part + |
| Measurement | Frequency | Phase angle | | imaginary |
| points | (GHz). | (degree) | impedance | part) |
| m1 | 76.0 | −18.35 | 0.264 | 1.636 − 0.292i |
| m2 | 78.5 | 111.21 | 0.293 | 0.704 + 0.421i |
| m3 | 81.0 | −129.97 | 0.295 | 0.621 − 0.309i |

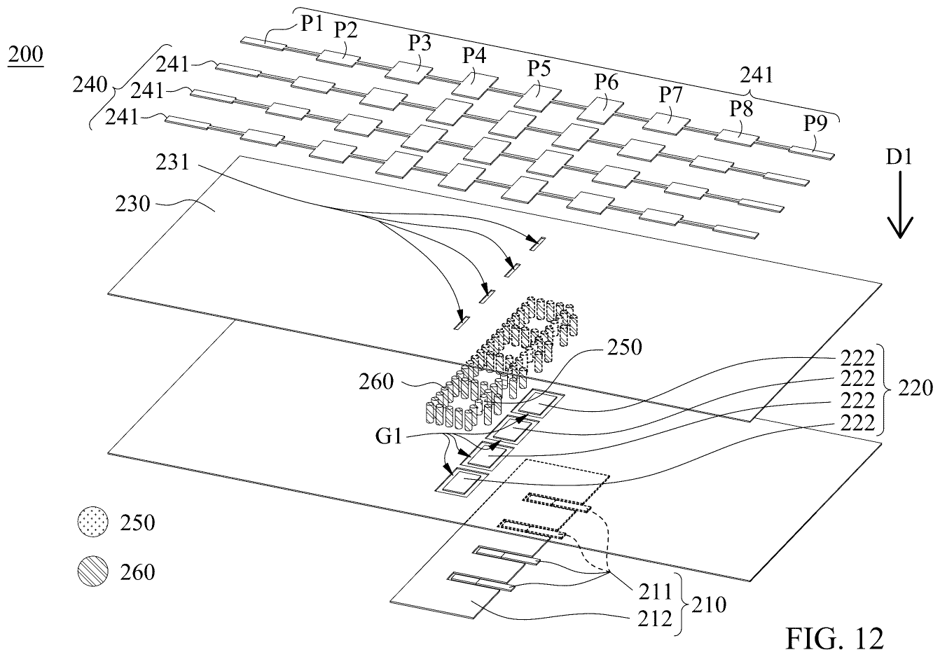

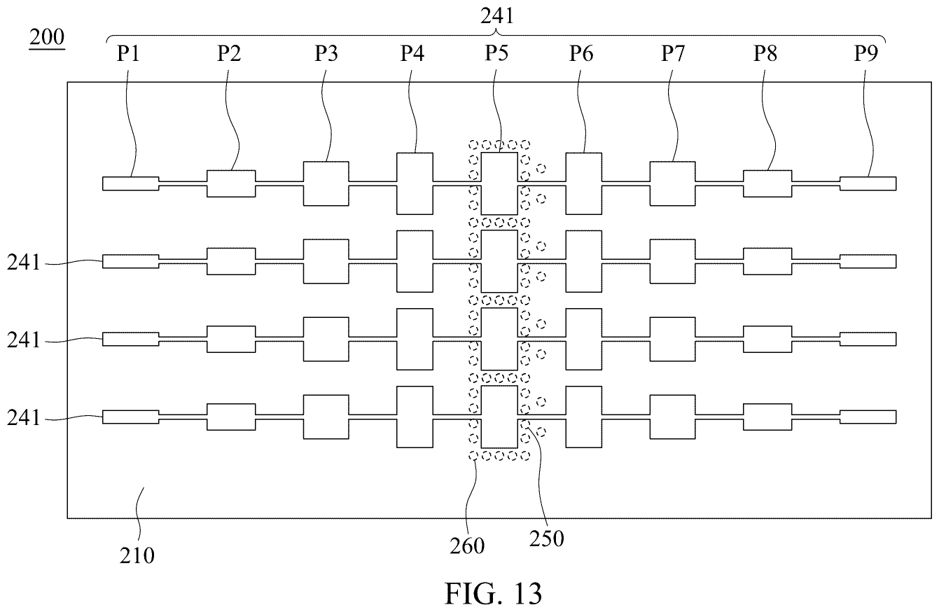

Referring to FIG. 12 and FIG. 13. FIG. 12 is a schematic decomposition view of an antenna structure 200 according to a second embodiment of the present disclosure. FIG. 13 is a perspective view of the antenna structure 200 of FIG. 12. The antenna structure 200 includes a feeding layer 210, a patch antenna layer 220, a slot antenna layer 230, a serial patch antenna layer 240, a plurality of first via structures 250, and a plurality of second via structures 260. The feeding layer 210 includes a plurality of feeding portions 211 and a grounding layer 212. The feeding portions 211 are configured to feed a plurality of signals respectively. The patch antenna layer 220 includes a grounding layer 221 and a plurality of patch antennas 222. A spacing G1 is between the grounding layer 221 and each of the patch antennas 222, and the patch antennas 222 correspond to the feeding portions 211 respectively. The slot antenna layer 230 includes a plurality of slots 231, and the slots 231 correspond to the patch antennas 222 respectively. The serial patch antenna layer 240 includes a plurality of serial patch antenna groups 241. Each of the serial patch antenna groups 241 includes a plurality of patch antenna units P1-P9. One of the patch antenna units P1 to P9 of each of the serial patch antenna groups 241 partially overlaps with the feeding portions 211 in a vertical projection direction D1. The first via structures 250 are connected to the slot antenna layer 230 and the patch antennas 222. The second via structures 260 are connected to the slot antenna layer 230 and the feeding layer 210. The signals are from the feeding layer 210 through the patch antenna layer 220, the slot antenna layer 230, and couple and resonate with the serial patch antenna layer 240.

Therefore, the antenna structure 200 of the present disclosure can be applied to Multiple Input Multiple Output (MIMO) automotive radar equipment.

From the above embodiment, the antenna structure of the present disclosure has the following advantages. First, solving beam squint. Second, improving radiation effect and avoiding long line effects. Third, the error of the via structures made in the manufacturing process will not affect the efficiency and frequency performance. Fourth, it can be applied to MIMO automotive radar equipment.

The foregoing description of the disclosure has been presented only for the purposes of illustration and description option of the exemplary embodiments and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna structure comprising:
a feeding layer comprising a feeding portion configured to feed a signal;
a patch antenna layer comprising a grounding layer and a patch antenna, wherein a spacing is between the grounding layer and the patch antenna, and the patch antenna corresponds to the feeding portion;
a slot antenna layer comprising a slot corresponding to the patch antenna;
a serial patch antenna layer comprising a serial patch antenna group, the serial patch antenna group comprising a plurality of patch antenna units, one of the patch antenna units partially overlapping with the feeding portion in a vertical projection direction;
a plurality of first via structures connected to the slot antenna layer and the patch antenna layer; and
a plurality of second via structures connected to the slot antenna layer and the feeding layer;
wherein the signal is from the feeding layer through the patch antenna layer, the slot antenna layer, and couples and resonates with the serial patch antenna layer.

2. The antenna structure according to claim 1, wherein a setting position of the feeding portion corresponds to a middle position of the serial patch antenna layer.

3. The antenna structure according to claim 1, wherein a number of the patch antenna units is an odd number, when the number of the patch antenna units is N, a setting position of the feeding portion corresponds to (N+1)/2 of the patch antenna units.

4. The antenna structure according to claim 1, wherein when the patch antenna layer and the slot antenna layer are observed along the vertical projection direction, the first via structures and the second via structures surround the spacing and the patch antenna.

5. The antenna structure according to claim 4, wherein at least a part of the first via structures and the second via structures are arranged at equal intervals.

6. The antenna structure according to claim 5, wherein the feeding portion is a microstrip antenna, and a setting position of the first via structures corresponds to the microstrip antenna.

7. The antenna structure according to claim 1, wherein the antenna structure has a resonance frequency between 76 GHz and 81 GHz.

8. An antenna structure comprising:
a feeding layer comprising a plurality of feeding portions respectively configured to feed a plurality of signals;
a patch antenna layer comprising a grounding layer and a plurality of patch antennas, wherein a spacing is between the grounding layer and each of the patch antennas, and the patch antennas respectively correspond to the feeding portions;
a slot antenna layer comprising a plurality of slots respectively corresponding to the patch antennas;
a serial patch antenna layer comprising a plurality of serial patch antenna groups, each of the serial patch antenna groups comprising a plurality of patch antenna units, and one of the patch antenna units of each of the serial patch antenna groups partially overlapping with the feeding portions in a vertical projection direction;
a plurality of first via structures connected to the slot antenna layer and the patch antenna layer; and
a plurality of second via structures connected to the slot antenna layer and the feeding layer;
wherein the signals are from the feeding layer through the patch antenna layer, the slot antenna layer, and couple and resonate with the serial patch antenna layer.

9. The antenna structure according to claim 8, wherein a setting position of each of the feeding portions corresponds to a middle position of the serial patch antenna layer, and the antenna structure has a resonance frequency between 76 GHz and 81 GHz.

10. The antenna structure according to claim 8, wherein when the patch antenna layer and the slot antenna layer are observed along the vertical projection direction, the first via structures and the second via structures surround the patch antennas, and at least a part of the first via structures and the second via structures are arranged at equal intervals;
each of the feeding portions is a microstrip antenna, and a setting position of each of the first via structures corresponds to the microstrip antenna.
